(19) United States
(12) Patent Application Publication
(10) Pub. No.: US 2008/0290761 A1
(43) Pub. Date: Nov. 27, 2008

(54) Interface Module for Arranging in or on a Motor

(75) Inventors: Rainer Eckert, Bad Neustadt/Herschfeld (DE); Markus Platen, Bad Neustadt (DE); Karl-Heinz Filbry, Hochheim (DE); Ulrich Hohn, Hollstadt/Junkershausen (DE); Hans-Werner Lipot, Bad Neustadt (DE); Michael Zisler, Euerdorf-Wirmsthal (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/911,382

(22) PCT Filed: Apr. 7, 2006
(86) PCT No.: PCT/EP2006/061452

§ 371 Date: Jun. 9, 2008

(30) Foreign Application Priority Data
Apr. 12, 2005 (DE) 10 2005 016 855.8

(51) Int. Cl. H02K 11/00; H02P 31/00

(52) U.S. Cl. 310/68 B; 318/490

(57) ABSTRACT

Temperature or vibration sensors (14) are often used, in addition to a transmitter (13), to monitor a motor (12). The aim of the invention is to simplify the transmission of the sensor signals of a plurality of sensor devices (13,14) mounted in or on a motor (12). To this end, an interface module (15) is mounted in or on a motor (12), especially in or on an electric motor, said interface module comprising a processing device for receiving and processing a first sensor signal emitted by a first sensor component (13). The first sensor component (13) is embodied in such a way as to detect a first physical variable and to emit the first sensor signal, and the processing device is embodied in such a way as to additionally receive and process a second sensor signal emitted by a second sensor component (14). The second sensor component (14) is used to detect a second physical variable and to emit the second sensor signal.

The present invention relates to an interface module for arranging in or on a motor, in particular in or on an electric motor, said module having a processing device for receiving and processing a first sensor signal from a first sensor component, the first sensor component being designed to detect a first physical variable and provide the first sensor signal.

Unplanned failures of electric motors, for example as a result of bearing damage, may result in the failure of complex machines and systems, for example production lines. This gives rise to high consequential costs. Therefore, when using motors, there is great interest in an ability to diagnose the motors. In this case, monitoring the bearings and monitoring the brakes, in particular, are the focal point of interest.

Therefore, apart from detectors for determining a rotor position, temperature sensors for detecting the winding temperature and/or vibration sensors for monitor the bearings and for monitoring the brakes are also used in motors. These sensors detect a temperature or a vibration and provide a corresponding sensor signal for it.

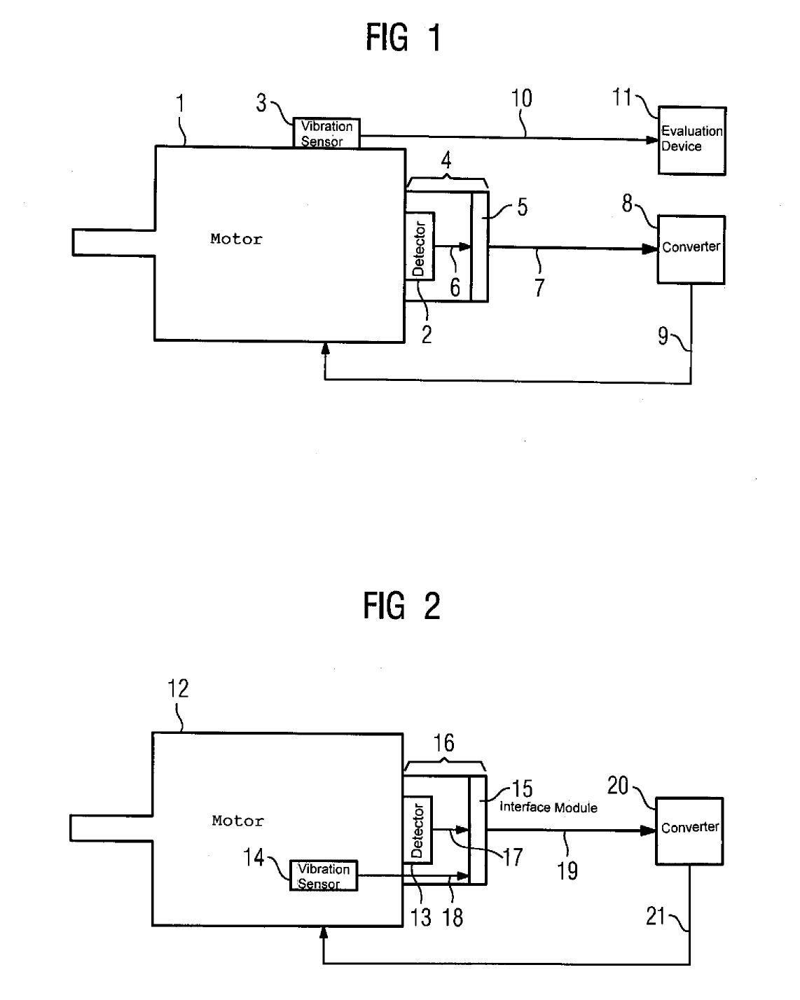

The generally known motor 1 which is illustrated in FIG. 1 has a detector 2 and a vibration sensor 3 as sensor devices. In this case, the detector 2 is used to determine a position of a rotor (not sketched in FIG. 1) of the motor 1. The detector 2 is arranged, with an interface module 5, in a detector installation space 4 on the motor 1. The interface module 5 detects the detector signal 6 and uses it to determine the current speed of the motor 1. The analog signal of the current speed is converted into a digital signal using an A/D converter of the interface module 5. The digital signal is then output to a converter 8 using the signal line 7.

The vibration sensor 3 is used to monitor the bearings. In order to evaluate the vibration sensor 3, its vibration signal is transmitted to an evaluation device 11 using a signal line 10. A line which is not sketched in FIG. 1 can then be used, if necessary, to provide the converter 8 with a corresponding information signal.

The converter 8 compares the current speed with a predefined desired speed and controls the power, which is supplied to the motor 1 using the power line 9, in a corresponding manner. The vibration signal detected by the vibration sensor 3 can also be taken into account when controlling the power of the motor 1.

One disadvantage of a motor 1 having a detector 2 and a vibration sensor 3 is that the operation of fitting the sensor devices 2 and 3 on the motor 1 and the operation of connecting the sensor devices 2 and 3 to their associated evaluation and control devices 5, 8 and 11 are labor-intensive.

Therefore, the object of the present invention is to find an apparatus which simplifies assembly of the motor, the sensor devices fitted in or on the latter and the associated evaluation or control components.

According to the invention, the object is achieved by means of an interface module for arranging in or on a motor, in particular in or on an electric motor, said module comprising a processing device for receiving and processing a first sensor signal from a first sensor component, the first sensor component being designed to detect a first physical variable and provide the first sensor signal, the processing device being designed to additionally receive and process a second sensor signal from a second sensor component, the second sensor component being designed to detect a second physical variable and provide the second sensor signal.

As sketched in FIG. 1, when fitting a plurality of sensor devices 2 and 3 in or on a motor 1, the problem arises of having to fit an associated signal line 7 or 10, which leads from the motor 1 to an evaluation, processing or control device 8 and 11 which is not arranged on the motor 1, for each sensor device according to the prior art. In contrast, the sensor signals from different sensors can be transmitted to an evaluation or control device, which is not arranged on the motor, using a common line by means of an interface module according to the invention. This also facilitates joint evaluation of the sensor signals from a plurality of sensor components. In this case, an interface module may be designed in such a manner that, in addition to the sensor signals from the first and second sensor components, sensor signals from further sensor components are also processed using the interface module.

The processing device may preferably comprise a common A/D converter device and/or a common bus interface for both sensor signals. This facilitates joint transmission of the sensor signals from different sensor components.

The present invention can also be applied if the first physical variable is different to the second physical variable. In this case, a difference between the first and second physical variables is understood as meaning that the physical variables detected have different units. The present invention can therefore be used for different types of sensors.

For example, the first sensor component and/or the second sensor component is/are a detector, a temperature sensor or a vibration sensor. As already mentioned in the introduction, temperature sensors and vibration sensors, in particular, are used, in addition to a detector, when monitoring a motor. Therefore, it is advantageous that the present invention can also be applied to said temperature and vibration sensors.

The interface module advantageously comprises a hardware component and a software component. These components can be used to evaluate or store the sensor signals. Integrating the hardware and software components in the interface module makes it possible to greatly simplify evaluation of the sensor signals inside the interface module.

Furthermore, the interface module may comprise the first sensor component and/or the second sensor component. Integrating at least one sensor component in the interface module dispenses with the additional labor required to mount the sensor component on the motor. It is particularly advantageous in this case if the sensor components have already been initialized in the factory for their method of operation and the motor components monitored by them, for example at least one bearing or brake of a motor. This considerably reduces the effort needed to start up the entire system.

In the present invention, the first sensor component may be able to be used to detect a temperature of the motor and to provide an input variable for a temperature model of the motor for the purpose of monitoring a bearing of the motor. This ensures that the bearing of the motor is monitored reliably.

In particular, the interface module may be able to be plugged onto the motor. This can be achieved by designing the housing of the interface module in the form of a plug. As a result, the operation of fitting the interface module on or inside the motor can also be carried out in a simple manner and is associated with little labor and time.

The present invention will now be explained in more detail using the accompanying drawings, in which:

FIG. 1 shows an interface module according to the prior art; and

FIG. 2 shows a sensor and interface module according to the invention.

The exemplary embodiment described in more detail below constitutes one preferred embodiment of the present invention.

Like the motor 1 from FIG. 1, the motor 12 from FIG. 2 has a detector 13 and a vibration sensor 14. In this case, with the motor 12, the vibration sensor 14 was fitted inside the motor 12 for better monitoring of the bearing. The detector 13 for determining the position of the rotor of the motor 12 is situated, together with a sensor and interface module 15 according to the invention, inside a detector installation space 16. The detector installation space 16 is fastened to the motor 12.

As an alternative or in addition to the vibration sensor 14, it is also appropriate to fit at least one temperature sensor in or on the motor 12. In addition to the vibration sensor 14, it is likewise possible to arrange yet further vibration sensors in or on the motor 12.

The sensor and interface module 15 according to the invention detects the sensor signals from the detector 13 and from the vibration sensor 14 by means of the lines 17 and 18. In this case, the sensor and interface module 15 may alternatively also be designed to detect the sensor signals from more than two sensor devices. In addition, the sensor and interface module 15 is connected to a bus system 19. In this case, the sensor and interface module 15 comprises evaluation devices which, in addition to determining the current speed, also allow the vibration signal from the vibration sensor 14 to be evaluated. Therefore, in a motor 12 having a sensor and interface module 15 according to the invention, it is possible to dispense with fitting an evaluation device 11, as in the example from FIG. 1. The sensor and interface module 15 also has an A/D converter.

After evaluating the detector signal and the vibration signal, the sensor and interface module 15 outputs the evaluation signals to a converter 20 of the motor 12 by means of a bus system 19, for example in accordance with the Ethernet format. After comparing the detected values with predefined desired values, the converter 20 controls the power, which is supplied to the motor 12 by means of the power line 21, in accordance with the comparison result.

However, it is likewise also possible to display values which are detected using the present invention, for example the state of the bearing, on a superordinate controller. According to the previous prior art, the state of the bearing is displayed only on the motor 12, which is disadvantageous for a user of the motor 12. As a result of the state of the bearing being displayed on a superordinate controller which is connected to the bus system 19, it is easier for a user of the motor 12 to control an expedient load on the motor 12.

Furthermore, evaluation devices for evaluating the sensor signals detected by the sensor devices 13 and 14 in or on the motor 12 may be fitted in or on the converter 20. In this case, the sensor and interface module 15 comprises only partial evaluation or processing devices which convert the sensor signals into their format for data transmission using a bus system 19, for example.

Bidirectional data transmission may also be possible using a sensor and interface module 15 according to the invention.

This then also ensures that one or more sensor devices are controlled using a superordinate system or the converter 20. Central intelligence is thus fitted in or on a motor using the sensor and interface module 15 according to the invention.

The joint use of a single AND converter or a single data interface by a plurality of sensors in or on the motor makes it possible to considerably reduce the effort needed to produce and install the motor.

1.-8. (canceled)

9. An interface module arranged in or on a motor, comprising:
a first sensor component configured to detect a first physical variable of the motor and to provide a first sensor signal in response to the first physical variable;
a second sensor component configured to detect a second physical variable of the motor and to provide a second sensor signal in response to the second physical variable; and
a processing device receiving the first and second sensor signals and processing the first and second sensor signals for transmission via a common line to an external control unit.

10. The interface module of claim 9, wherein the processing device includes a common bus interface for the first and second sensor signals.

11. The interface module of claim 9, wherein the processing device includes a common A/D converter receiving the first and second sensor signals transmitted via the common line.

12. The interface module of claim 9, wherein the first and second physical variables are different.

13. The interface module of claim 9, wherein at least one of the first and second sensor components is a member selected from the group consisting of a detector, a temperature sensor, and a vibration sensor.

14. The interface module of claim 9, further comprising a hardware component and a software component.

15. The interface module of claim 9, wherein at least one of the first and second sensor components is integrated in the interface module.

16. The interface module of claim 9, wherein at least one of the first and second sensor components is a temperature sensor configured to detect a temperature of the motor, and wherein the sensor signal produced by the temperature sensor is supplied to a temperature model of the motor for monitoring a bearing performance of the motor.

17. The interface module of claim 9, wherein the motor is an electric motor.

18. The interface module of claim 9, constructed for plug connection to the motor.

19. The interface module of claim 9, further comprising a housing configured as a plug connector for attachment a mating member inside the motor.
